(19) United States
(12) Patent Application Publication
(10) Pub. No.: US 2015/0183099 A1
(43) Pub. Date: Jul. 2, 2015

(54) CONNECTING STRUCTURE OF TORQUE TIRE ARBOR

(71) Applicant: Wei-Ning HSIEH, Taichung City (TW)

(72) Inventor: Wei-Ning HSIEH, Taichung City (TW)

(21) Appl. No.: 14/144,533

(22) Filed: Dec. 30, 2013

(51) Int. Cl. B25B 23/142; B60C 23/04

(52) U.S. Cl. CPC B25B 23/1425; B60C 23/04

(57) ABSTRACT

A connecting structure of a torque tire contains a body and a connecting assembly. The body includes a driving column and a digital seat, the driving column has a connecting segment for coupling with a wrench and a working segment for coupling with a socket, the body also includes a torque sensing unit for sensing a torque value, and the digital seat includes a first electricity conducting segment. The connecting assembly includes a coupling segment for fitting with the driving column, a second electricity conducting segment connecting with the first electricity conducting segment, a measuring mouth for joining with an air nozzle of a tire, and a pressure sensing unit for detecting a tire pressure value. The digital seat includes a display unit electrically coupled with the torque sensing unit and the first electricity conducting segment so as to display the torque value and the tire pressure value.

### FIELD OF THE INVENTION

The present invention relates to a connecting structure of a torque tire arbor which not only can sense torque pound of locking a tire but also can measure the tire pressure value of the tire after replacing the tire.

### BACKGROUND OF THE INVENTION

A conventional digital torque wrench is disclosed in TW Patent No. 1376294 and contains a body formed in a hollow tube shape; a driving head including a head end and a strain section extending to the head end and disposed in the body; at least one strain sensor mounted on the strain section; a torque setting device fixed on the body and arranged to input a preset torque; a comparator secured on the body and coupling with the strain sensor and the torque setting device; and an electromagnetic force releasing component including an adjustable moving rod formed on the body and corresponding to the driving head, wherein the electromagnetic force releasing component is electrically connected with the comparator; and the moving rod extends outwardly or retracts backwardly to interfere the driving head, thus limiting the driving head.

However, when replacing a tire, the digital torque wrench cannot measure a tire pressure value of a tire after replacing the tire.

The present invention has arisen to mitigate and/or obviate the afore-described disadvantages.

### SUMMARY OF THE INVENTION

The primary object of the present invention is to provide a connecting structure of a torque tire arbor which not only can sense torque pound of locking a tire but also can measure the tire pressure value of the tire after replacing the tire

To obtain the above objective, a connecting structure of a torque tire arbor provided by the present invention contains: a body and a connecting assembly.

The body includes a driving column and a digital seat, the digital seat covers and connects with the driving column, the driving column has a connecting segment defined on a first end thereof so as to couple with a wrench and a working segment formed on a second end thereof so as to join with a socket, the body also includes a torque sensing unit for sensing a torque value, the digital seat includes a first electricity conducting segment formed on a surface thereof.

The connecting assembly includes a coupling segment formed on a first end thereof so as to fit with the driving column, a second electricity conducting segment disposed on a surface thereof proximate to the coupling segment and connecting with the first electricity conducting segment, a measuring mouth defined on a second end thereof so as to join with an air nozzle of a tire, and a pressure sensing unit secured on an inner wall of the measuring mouth and connecting with the second electricity conducting segment so as to detect a tire pressure value.

The digital seat includes a display unit electrically coupled with the torque sensing unit and the first electricity conducting segment so as to display the torque value and the tire pressure value.

### BRIEF DESCRIPTION OF THE DRAWINGS

FIG. 1 is a perspective view showing the exploded components of a connecting structure of a torque tire arbor according to a preferred embodiment of the present invention.

FIG. 2 is a perspective view showing the assembly of the connecting structure of the torque tire arbor according to the preferred embodiment of the present invention.

FIG. 3 is a cross sectional view showing the assembly of the connecting structure of the torque tire arbor according to the preferred embodiment of the present invention.

FIG. 4 is a perspective view showing the application of the connecting structure of the torque tire arbor according to the preferred embodiment of the present invention.

### DETAILED DESCRIPTION OF THE PREFERRED EMBODIMENTS

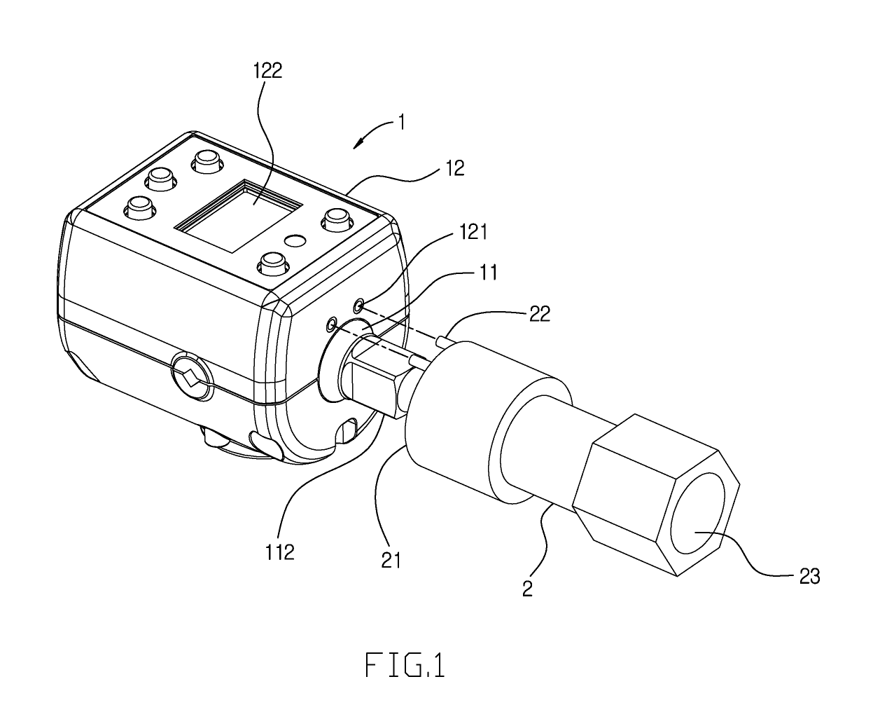

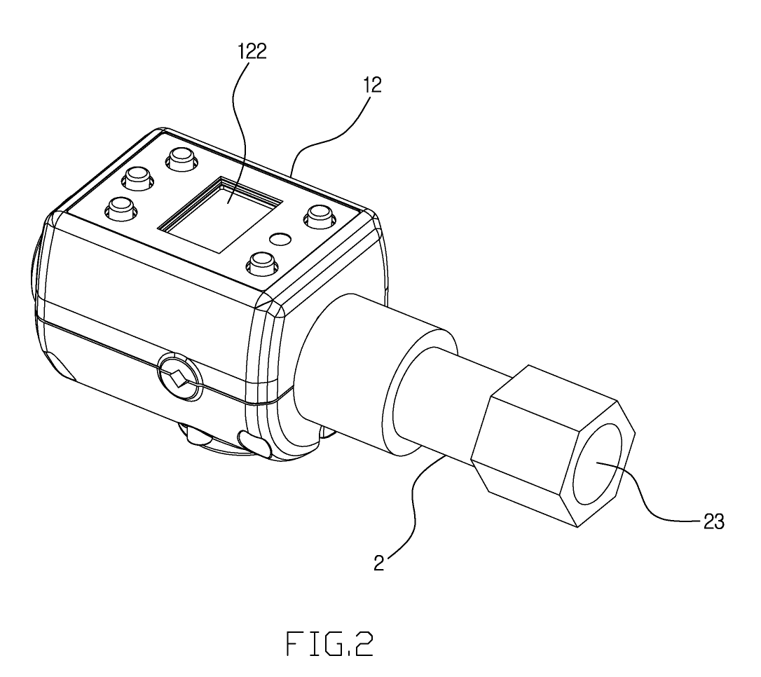

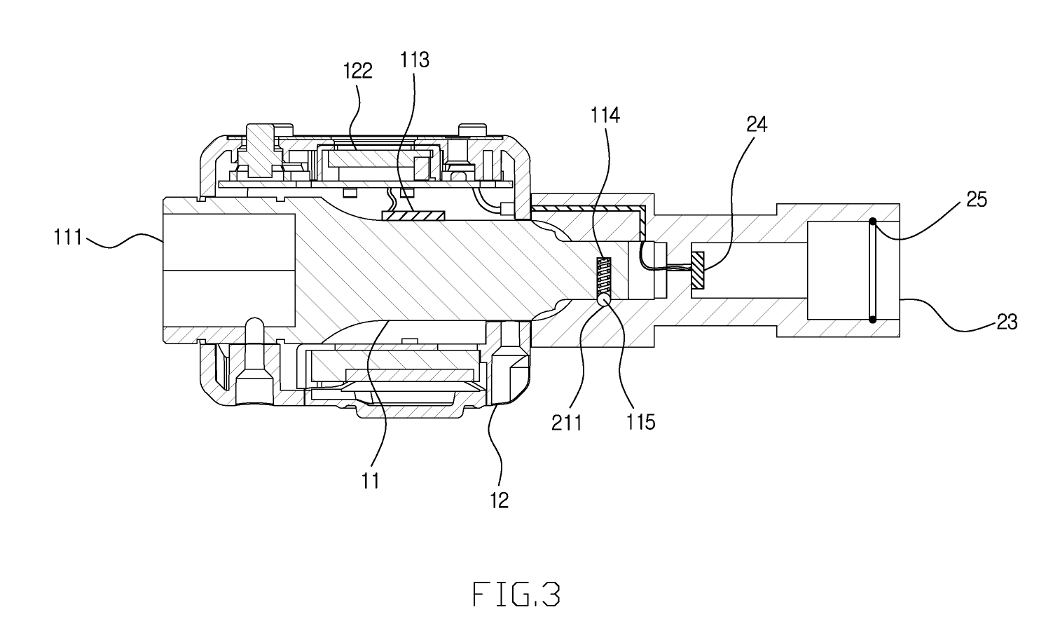

With reference to FIGS. 1-4, a connecting structure of a torque tire arbor according to a preferred embodiment of the present invention comprises a body 1 and a connecting assembly 2;

the body 1 includes a driving column 11 and a digital seat 12, the digital seat 12 covers and connects with the driving column 11, the driving column 11 has a connecting segment 111 defined on a first end thereof so as to couple with a wrench and a working segment 112 formed on a second end thereof so as to couple with a socket. The body 1 also includes a torque sensing unit 113 for sensing a torque value, the digital seat 3 includes a first electricity conducting segment 121 formed on a surface thereof;

the connecting assembly 2 includes a coupling segment 21 formed on a first end thereof so as to fit with the driving column 11, a second electricity conducting segment 22 disposed on a surface thereof proximate to the coupling segment 21 and connecting with the first electricity conducting segment 121 (in this embodiment, the first electricity conducting segment 121 is a metal socket, and the second electricity conducting segment 22 is a metal plug), a measuring mouth 23 defined on a second end thereof so as to join with an air nozzle of a tire, and a pressure sensing unit 24 secured on an inner wall of the measuring mouth 23 and connecting with the second electricity conducting segment 22 so as to detect a tire pressure value;

the digital seat 12 includes a display unit 122 electrically coupled with the torque sensing unit 113 and the first electricity conducting segment 121 so as to display the torque value and the tire pressure value.

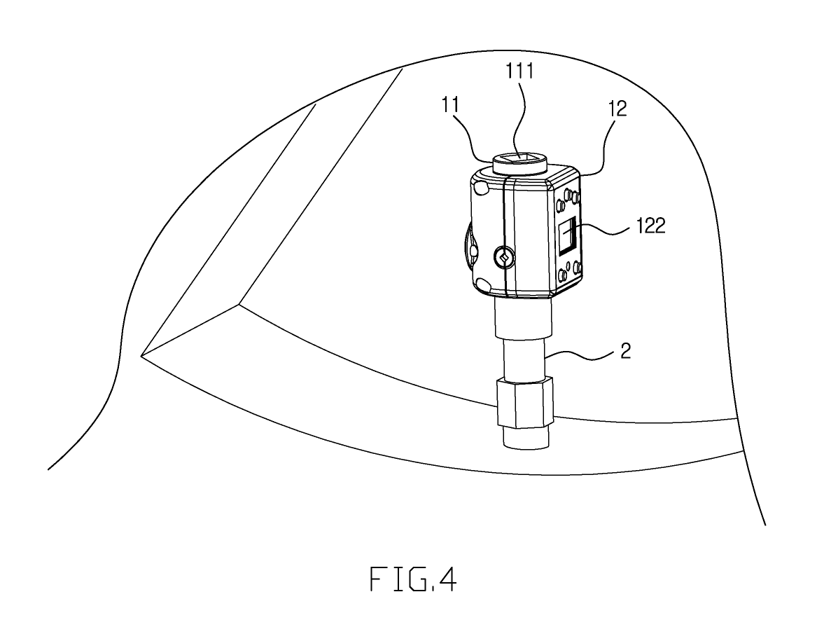

Thereby, in tire replacement operation, the body 1 not only can sense torque pound of locking a tire but also can fit with the connecting assembly 2 so that the connecting assembly 2 measures the tire pressure value of the tire after replacing the tire (as shown in FIG. 4).

In addition, the measuring mouth 23 has an airtight rubber ring 25 fitted around the inner wall thereof, such that when the measuring mouth 23 is coupled with the air nozzle of the tire, air in the tire will not leak.

Furthermore, the torque sensing unit 113 is a torque strain gauge attached on an outer surface of the driving column 11.

The coupling segment 21 is a recess for fitting with the working segment 112, the working segment 112 has a spring 114 and a steel ball 115, and the coupling segment 21 has a notch 211 formed on an inner wall thereof so as to retain with the steel ball 115, such that the connecting assembly 2 is coupled with the working segment 112 of the driving column 11 so as to prevent disengagement from the of the driving column 11.

In this embodiment, the coupling segment 21 is a recessed trench for fitting with the working segment 112 which is protruded, but it can be also a protruded post for fitting with a recessed connecting segment 111 of the driving column 11.

Accordingly, the torque tire arbor not only can sense torque pound of locking the tire but also can measure the tire pressure value of the tire after replacing the tire.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A connecting structure of a torque tire comprising a body and a connecting assembly;
the body including a driving column and a digital seat, the digital seat covering and connecting with the driving column, the driving column having a connecting segment defined on a first end thereof so as to couple with a wrench and a working segment formed on a second end thereof so as to join with a socket, the body also including a torque sensing unit for sensing a torque value, the digital seat including a first electricity conducting segment formed on a surface thereof;
the connecting assembly including a coupling segment formed on a first end thereof so as to fit with the driving column, a second electricity conducting segment disposed on a surface thereof proximate to the coupling segment and connecting with the first electricity conducting segment, a measuring mouth defined on a second end thereof so as to join with an air nozzle of a tire, and a pressure sensing unit secured on an inner wall of the measuring mouth and connecting with the second electricity conducting segment so as to detect a tire pressure value;
the digital seat including a display unit electrically coupled with the torque sensing unit and the first electricity conducting segment so as to display the torque value and the tire pressure value.

2. The connecting structure of the torque tire as claimed in claim 1, wherein the measuring mouth has an airtight rubber ring fitted around the inner wall thereof.

3. The connecting structure of the torque tire as claimed in claim 1, wherein the torque sensing unit is a torque strain gauge attached on an outer surface of the driving column.

4. The connecting structure of the torque tire as claimed in claim 1, wherein the coupling segment is a recess for fitting with the working segment, the working segment has a spring and a steel ball, and the coupling segment has a notch formed on an inner wall thereof so as to retain with the steel ball.
